(19) United States
(12) Patent Application Publication
(10) Pub. No.: US 2008/0253685 A1
(43) Pub. Date: Oct. 16, 2008

(54) Image and video stitching and viewing method and system

(75) Inventors: Alexander Kuranov, Nizhny Novgorod (RU); Deepak Gaikwad, Pune (IN); Vaidhi Nathan, San Jose, CA (US); Sergey Egorov, Nizhny Novgorod (RU); Tejashree Dhoble, East Windsor, CT (US)

Correspondence Address: DAVID LEWIS, 1250 AVIATION AVE., SUITE 200B, SAN JOSE, CA, 95110, US

(73) Assignee: IntelliVision Technologies Corporation

(21) Appl. No.: 12/072,186

(22) Filed: Feb. 25, 2008

Related U.S. Application Data
(60) Provisional application No. 60/903,026, filed on Feb. 23, 2007.

(51) Int. Cl. G06K 9/36

(52) U.S. Cl. 382/284

(57) ABSTRACT

Multiple images taken from different locations or angles and viewpoints are joined and stitched. After the stitching and joining a much larger video or image scenery may be produced than any one image or video form which the final scenery was produced or an image of a different perspective than any of the input images may be produced.

### CROSS-REFERENCE TO RELATED APPLICATIONS

This application claims priority benefit of U.S. Provisional Patent Application No. 60/903,026 (Docket #53-4), filed Feb. 23, 2007, which is incorporated herein by reference.

### FIELD

The method relates in general to video and image processing.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In the prior art, a still picture or video is taken of a scene. At times different images are taken from different perspectives, which may be shown at different times to give the viewer a more complete view of the incident. However, the different perspectives do not always give a complete picture. Also, combined images often have transitions that do not look natural.

### SUMMARY

A method and a system are provided for joining and stitching multiple images or videos taken from different locations or angles and viewpoints. In this specification the word image is generic to a video image or a still image. In an embodiment, a video panorama or a still image panorama may be automatically constructed from a single video or multiple videos. Video images may be used for producing video or still panoramas, and portions of a single still image or multiple still images may be combined to construct a still panorama. After the stitching and joining a much larger video or image scenery may be produced than any one image or video from which the final scenery was produced. Some methods that may be used for joining and representing the final scene include both automatic and manual methods of stitching and/or joining images. The methods may include different degrees of adjusting features, and blending and smoothening of images that have been combined. The method may include a partial window and/or viewing ability and a self-correcting/self-adjusting configuration. The word “stitching” refers to joining images (e.g., having different perspectives) to form another image (e.g., of a different perspective than the original images from which the final image is formed). The system can be used for both still images and videos and can stitch any number of scenes without limit. The system can provide higher performance by “stitching on demand” only the videos that are required to be rendered based on the viewing system. The output can be stored in a file system, or displayed on a screen or streamed over a network for viewing by another user, whom may have the ability to view a partial or a whole scene. The streaming of data refers to the delivering of data in packets, where the packets are in a format such that the packets may be viewed prior to receiving the entire message. By streaming the data, the packets are presented (e.g., viewed), the information delivered appears like a continuous stream of information. The viewing system may include an ability to zoom, pan, and/or tilt the final virtual stitched image/video seamlessly.

Any of the above embodiments may be used alone or together with one another in any combination. Inventions encompassed within this specification may also include embodiments that are only partially mentioned or alluded to or are not mentioned or alluded to at all in this brief summary or in the abstract.

### BRIEF DESCRIPTION

In the following drawings like reference numbers are used to refer to like elements. Although the following figures depict various examples of the invention, the invention is not limited to the examples depicted in the figures.

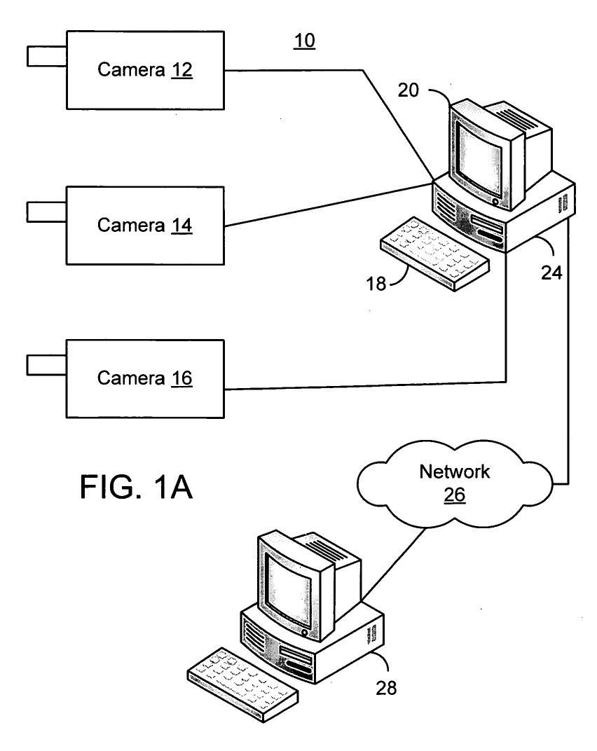

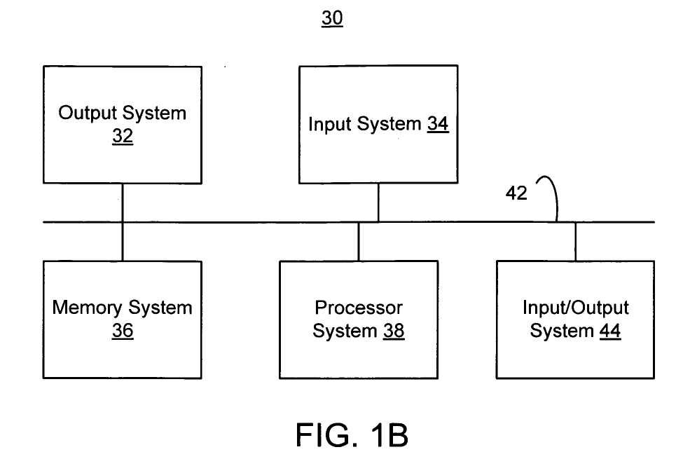

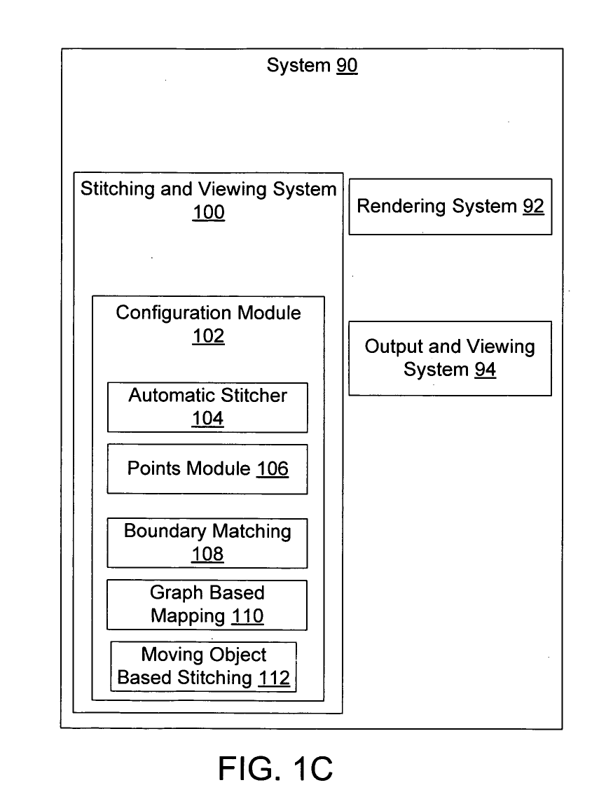

FIG. 1A shows an embodiment of a system for manipulating images.

FIG. 1B shows a block diagram of a system FIG. 1A, which may be an embodiment of the processor system or the client system.

FIG. 1C shows a block diagram of an embodiment of a memory system associated with FIG. 1A or 1B.

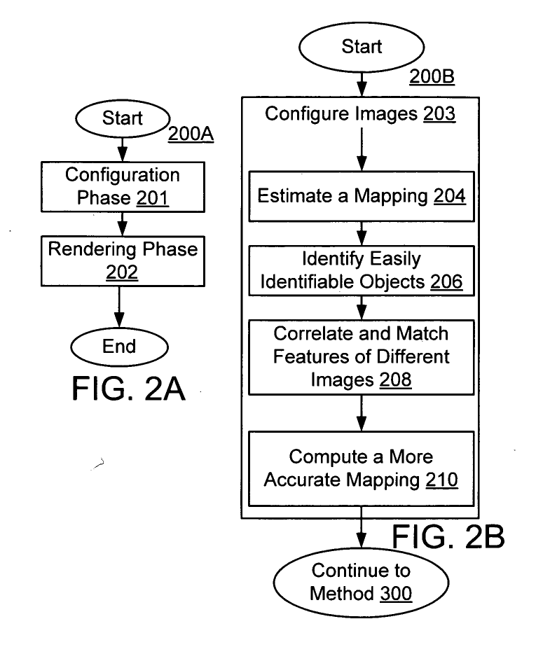

FIG. 2A is flowchart of an example of automatically stitching a scene together.

FIG. 2B is flowchart of an example of configuring a scene together.

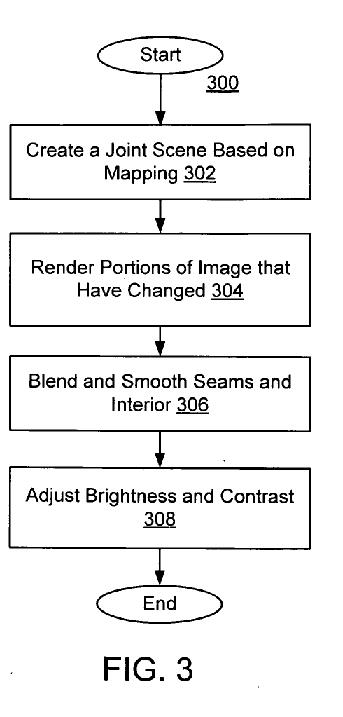

FIG. 3 shows a flow chart an example of a method of rendering the images produced by a stitching and viewing system associated with FIGS. 1A-C.

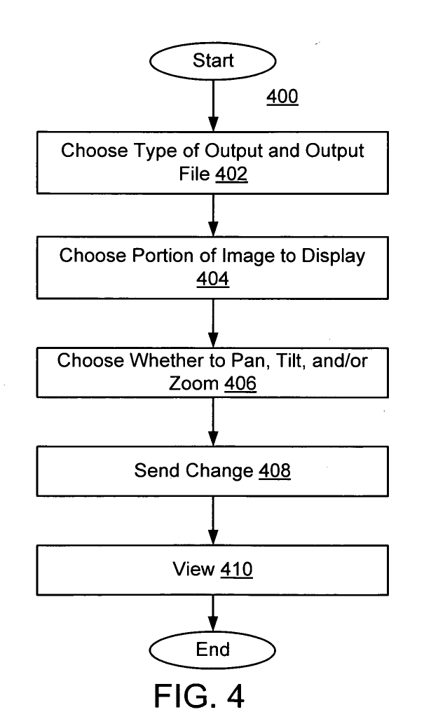

FIG. 4 is a flowchart of an example of a method of outputting and viewing scenes.

FIG. 5 is a flowchart for an example of a method of joining images or videos into a scene based on point.

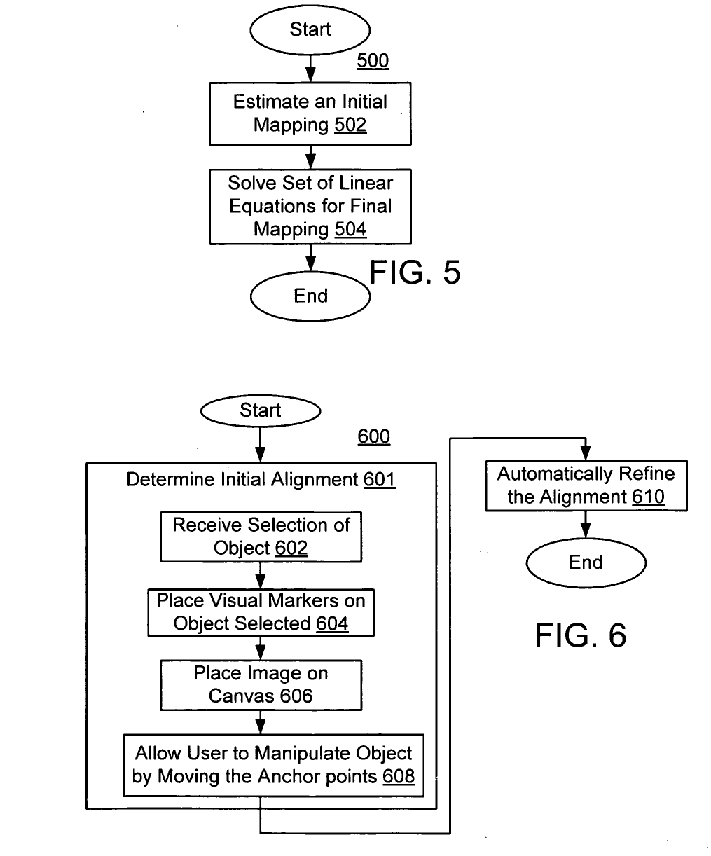

FIG. 6 is a flowchart of an example of a method of manually aligning images or videos based on the outer boundary.

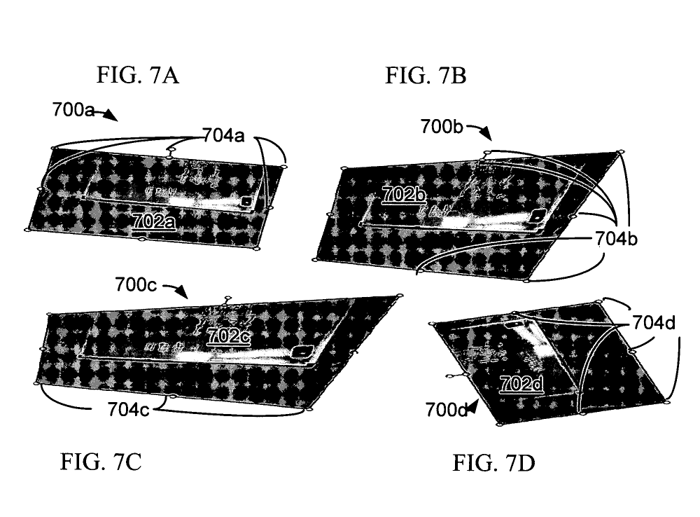

FIG. 7A-D shows an example of several images being aligned at different perspectives.

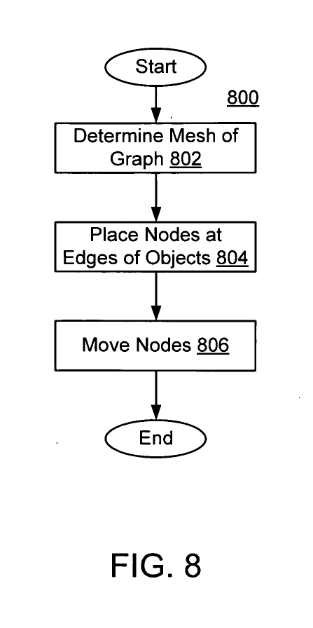

FIG. 8 shows a flowchart of an embodiment of a method for a graph based alignment.

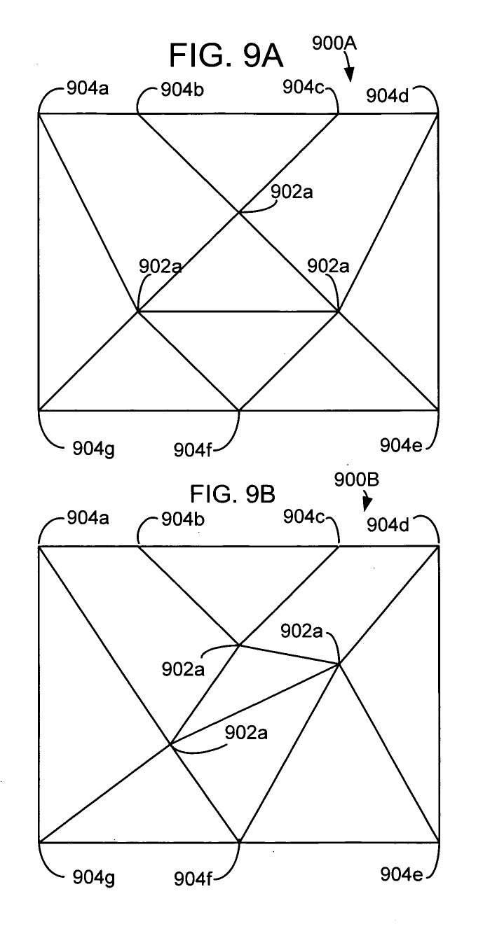

FIG. 9A shows an example of an unaltered image created with constrained points.

FIG. 9B shows an example of an altered image created with constrained points.

FIG. 9C shows an example of an image prior to adding a mesh.

FIG. 9D shows the image of FIG. 9C after a triangular mesh was added.

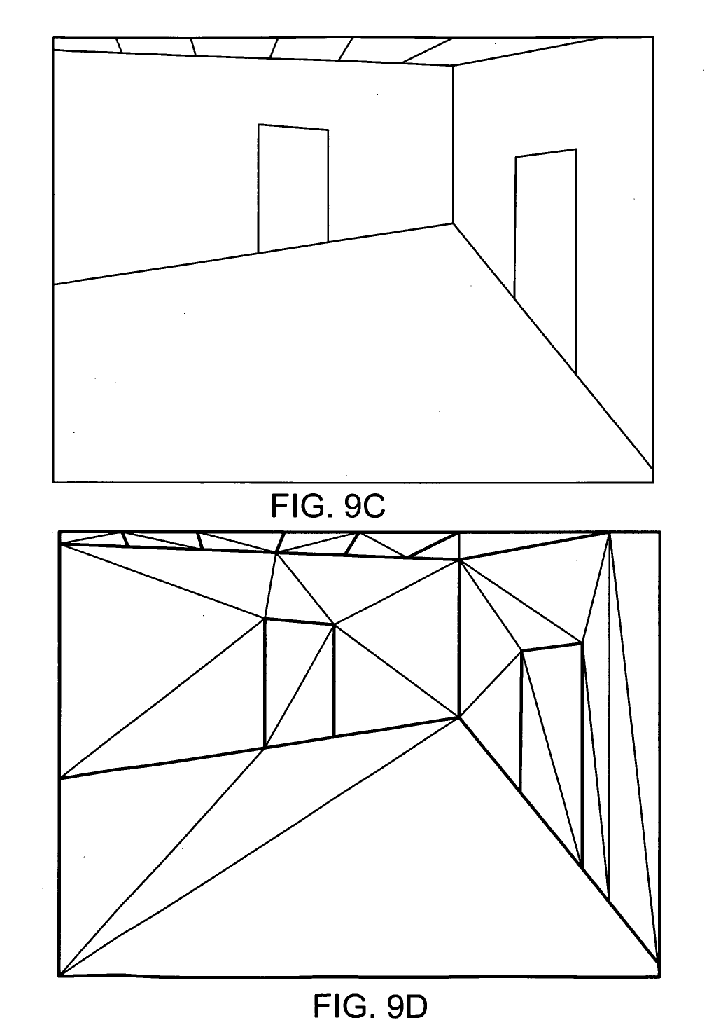

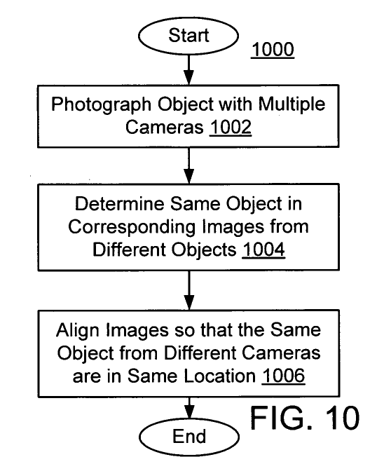

FIG. 10 shows a flowchart of an example a method of joining images based on a common moving object.

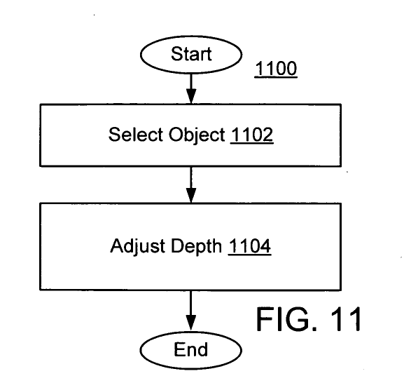

FIG. 11 is a flowchart of an embodiment of a method of adjusting the scene by adjusting the depth of different objects.

FIG. 12 is a flowchart of an embodiment of a method of rending an image, which may be implemented by rendering system of FIG. 1C.

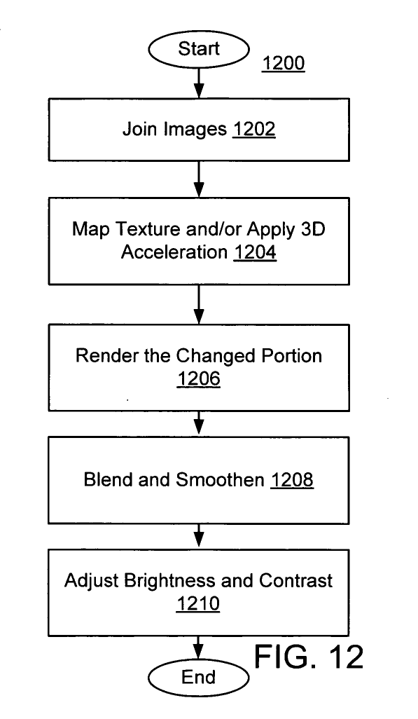

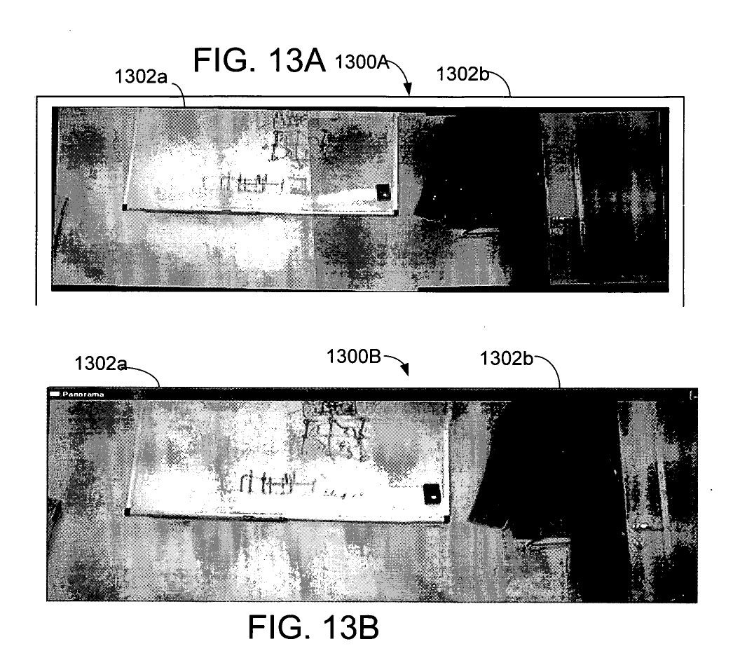

FIG. 13A shows an example of an image that has not been smoothed.

FIG. 13B shows an example of an image that has been smoothed.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

In general, at the beginning of the discussion of each of FIGS. 1A-9D is a brief description of each element, which may have no more than the name of each of the elements in the one of FIGS. 1A-9D that is being discussed. After the brief description of each element, each element is further discussed in numerical order. In general, each of FIGS. 1A-13B is discussed in numerical order and the elements within FIGS. 1A-13B are also usually discussed in numerical order to facilitate easily locating the discussion of a particular element. Nonetheless, there is no one location where all of the information of any element of FIGS. 1A-13B is necessarily located. Unique information about any particular element or any other aspect of any of FIGS. 1A-13B may be found in, or implied by, any part of the specification.

### The System

FIG. 1A shows an embodiment of a system 10 for manipulating images. System 10 may include cameras 12, 14, and 16, output device 18, input device 20, and processing system 24, network 26, and client system 28. In other embodiments, system 10 may not have all of the elements listed and/or may have other elements instead of or in addition to those listed.

Cameras 12, 14, and 16 may be video cameras, cameras that takes still images, or cameras that takes both still and video images. Each of cameras 12, 14 and 16 take an image from a different perspective than the other cameras. Cameras 12, 14, and 16 may be used for photographing images from multiple perspectives. The images taken by cameras 12, 14, and 16 are combined together to form a panorama. Although three cameras are illustrated by way of example, there may be any number of cameras (e.g., 1 camera, 2 cameras, 4 cameras, 8 cameras, 10 cameras, 16 cameras, etc.), each capturing images from a different perspective. For example, there may be only one camera and multiple images may be taken from the same camera to form a panorama.

Input device 18 may be used for controlling and/or entering instructions into system 10. Output device 20 may be used for viewing output images of system 10 and/or for viewing instructions stored in system 10.

Processing system 24 processes input images by combining the input images to form output images. The input images may be from one or more of cameras 12, 14, and 16 and/or from another source. Processor 22 may combine images from at least two sources or may combine multiple images from the same source to form a still image or video panorama. A user may swipe a scene with a single video camera, which creates just one video. From this one video, system 10 may automatically extract various sequential frames and take multiple images from the video. In an embodiment not every frame from the video is used. In another embodiment every frame from the video is used. Then system 10 stitches the frames that were extracted into one large final panorama image. Consequently one video input may be used to produce a panorama image output. Network 26 may be any Wide Area Network (WAN) and/or Local Area Network (LAN). Client system 28 may be any client network device, such as a computer, cell phone, and/or handheld computing device.

Although FIG. 1A depicts cameras 12, 14, and 16, output device 18, input device 20, and processing system 24 as physically separate pieces of equipment any combination of cameras 12, 14, and 16, output device 18, input device 20, and processing system 24 may be integrated into one or more pieces of equipment. Network 26 is optional. In an embodiment, the user may view the images rendered by processing system 24 at a remote location. The data viewed may be transferred via network 26. Client system 28 is optional. Client system 28 may be used for remote viewing of the images rendered. Thus, system 10 may have one or more videos as input and one panorama video output, one or more videos as input and one panorama still image output, one or more still images as inputs and one panorama still image output, one video input and one panorama still image output. Additionally the output may be displayed, stored in memory or in a file in a harddisk, sent to a printer, or streamed over a LAN/IP/Wireless Wifi-Bluetooth-cell.

FIG. 1B shows a block diagram of system 30 of FIG. 1A, which may be an embodiment of processor 24 or client system 28. System 30 may include output system 32, input system 34, memory system 36, processor system 38, communications system 42, and input/output device 44. In other embodiments, system 30 may not have all of the elements listed and/or may have other elements instead of or in addition to those listed.

Architectures other than that of system 30 may be substituted for the architecture of processor 24 or client system 28. Output system 32 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example. In an embodiment, output system 32 may also include an output storage area for storing images, and/or a projector for projecting the output and/or input images.

Input system 34 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for example. Input system 24 may include one or more of cameras, such as cameras 12, 14, and 16 and/or a port for uploading and/or receiving images from one or more cameras such as cameras 12, 14, and 16.

Memory system 36 may include, for example, any one of, some of, any combination of, or all of a long term storage system, such as a hard drive; a short term storage system, such as random access memory; a removable storage system, such as a floppy drive or a removable USB drive; and/or flash memory. Memory system 126 may include one or more machine readable mediums that may store a variety of different types of information. The term machine-readable medium is used to refer to any medium capable of carrying information that is readable by a machine. One example of a machine-readable medium is a computer-readable medium. Another example of a machine-readable medium is paper having holes that are detected that trigger different mechanical, electrical, and/or logic responses. All or part of memory 126 may be included in processing system 24. Memory system 36 is also discussed in conjunction with FIG. 1C, below.

Processor system 38 may include any one of, some of, any combination of, or all of multiple parallel processors, a single processor, a system of processors having one or more central processors and/or one or more specialized processors dedicated to specific tasks. Optionally, processing system 38 may include graphics cards (e.g., an OpenGL, a 3D acceleration, a DirectX, or another graphics card) and/or processors that specialize in, or are dedicated to, manipulating images and/or carrying out of the methods FIGS. 2A-13B. Processor system 38 may be the system of processors within processing system 24.

Communications system 42 communicatively links output system 32, input system 34, memory system 36, processor system 38, and/or input/output system 44 to each other. Communications system 42 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

Input/output system 44 may include devices that have the dual function as input and output devices. For example, input/output system 44 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 44 is optional, and may be used in addition to or in place of output system 122 and/or input device 44.

FIG. 1C shows a block diagram of an embodiment of system 90, which may include rendering system 92, output and viewing system 94, and stitching and viewing system 100. Stitching and viewing system 100 may include configuration module 102, automatic stitcher 104, points module 106, outer boundary mapping 108, graph based mapping 110, moving-object-based-stitching 112, and depth adjustment 114. In other embodiments, system 90 may not have all of the elements listed and/or may have other elements instead of or in addition to those listed. Each of rendering system 92, output and viewing system 94, and stitching and viewing system 100, and each of configuration module 102, automatic stitcher 104, points module 106, outer boundary mapping 108, graph based mapping 110, moving-object-based-stitching 112, and depth adjustment 114 may be separate modules, at illustrated. Alternatively, each of the boxes of FIG. 1C may represent different functions carried out by the software represented by FIG. 1C, which may be different lines of code inter-dispersed with one another.

System 90 may be a combination of hardware and/or software components. In an embodiment, system 90 is an embodiment of memory system 36, and each of the block represent portions of computer code. In another embodiment, system 90 is a combination of processing system 38 and memory system 36, and each block in system 90 may represent hardware and/or a portion of computer code. In another embodiment, system 90 includes all or any part of systems 10 and/or 30. Stitching and viewing system 100 stitches images together. Configuration module 102 configures images and videos. Automatic stitcher 104 automatically stitches portions of images together. Each of points module 106, outer boundary mapping 108, graph based mapping 110, and moving-object-based-stitching 112 perform different types of alignments, which may be used as alternatives to one another and/or together with one another. Points module 106 joins two or more images or videos together based on 3 or 4 points in common between two images. Outer boundary mapping 108 may be used to manually and/or automatically align images and/or videos by matching outer boundaries of objects. Graph based mapping 110 may form a graph of different images and/or videos, which are matched. The matching of graph based mapping 110 may perform a nonlinear mapping based on a mesh formed from the image and/or video. Moving-object-based-stitching 112 may perform an automatic stitching based on a common moving object. Depth adjustment 114 may adjust the depth and place different images at different levels of depth.

Returning to the discussion of configuration module 102, the mapping is a transformation that an image goes thru when it is aligned in the final Panorama. For example, Image/Scene 1, may be transformed linearly, when it is merged or applied to the final resulting Panorama image. A perspective transform is a more complex non-affine perspective transformation from the original image to the final panorama. For a simple scene or panorama—a linear mapping may be applied. For roads, complex roads, or for looking at a distance, a visual perspective mapping may be applied to make the panorama appear aesthetically pleasing and realistic. A perspective is a non-affine transformation determined by geometric principles applied to a two dimensional image. For example, the same car or person will look bigger or taller at a near distance and look smaller at a further distance. A graph or mesh transformation may be applied on more complex and hard to align panorama images, similar to a fish eye lens, there are lens distortions, or a combination of lens distortions and changes to account for different perspectives, etc. Then the images are joined via mesh graphs. The mesh nodes may be aligned manually or automatically. Inside each triangle node, a perspective or nonlinear transformation may be applied. In a mesh, the image is divided into segments, and each triangle segment transformed individually.

Rendering system 92 renders the panorama image created. Output and viewing system 94 may allow the user to output and view the panorama created with system 90 on a screen or monitor. Rending system 92 may produce a still image/Video Panoramas (VPs) may support stitching of different types of videos, cameras, and images. In the case of still images and/or videos, it may be possible to view the stitched panorama on a separate window. For rendering the panorama on a screen, two types of renderers may be used: a hardware renderer and/or a software renderer. The hardware renderer is faster and uses functions and library that are based on OpenGL, 3D acceleration, DirectX, or other graphics standard. On machines having a dedicated OpenGL graphics card, 3D acceleration graphics card, DirectX graphics card, or other graphics cards, the Central Processing Unit (CPU) usage is considerably less than for systems that do not have a dedicated graphics card and also rendering is faster on systems having a dedicated OpenGL, 3D acceleration, DirectX, or graphics other standard graphics card. A software renderer may require more CPU usage, because its rendering uses the operating system's (e.g., Windows®) functions for normal display. In an embodiment, the user may view the original videos in combination with the stitched stream. In an embodiment, the final panorama can be resized, zoomed, and/or stitched for better display.

Using output and viewing system 94, remote viewing may be facilitated by a Video Panorama (VP) system, which may support at least two kinds of network streams, which include a Transmission Control Protocol/User Datagram Protocol (TCP/UDP) (or another protocol) based server and client and a webserver and client. The TCP/UDP based server and client may be used for sending the VP stream over a Local Area Network (LAN), and the web-based server and client may be used for sending VP stream over the internet.

When using a TCP/UDP based server as output and viewing system 94, the user can select the port on which the user wants to send the data. The user can select the streaming type, such as RGB, JPEG, MPEG4, H26, custom compression formats, and/or other formats. JPEG is faster to send in a data stream, as compared to RGB raw data. Sockets (pointers to internal addresses, often referred to as ports, that are based on protocols for making connections to other devices for sending and/or receiving information) associated with the operating systems (e.g., Windows® sockets) may be used to send and receive data over the network. Initially when the user connects to a client, TCP protocol is used, because TCP protocol can give an acknowledgement of whether the server has successfully connected to the client or not. Until the server receives an acknowledgement of a successful connection, the server does not perform any further processing. System 10 (a VP system) may send some server-client specific headers for the handshaking process. Once system 10 receives the acknowledgment, another socket may be opened that uses the UDP protocol for transferring the actual image data. UDP has an advantage when sending the actual image, because UDP does not require for the server to understand whether the client received the image data or not. When using UDP, the server may start sending the frames without waiting for client's acknowledgement. This not only improves the performance, but also may facilitate sending the frames at a higher speed (e.g., frames per second). Also, to make the sending of data even faster, the scaling of image data (and/or other manipulations of the image) may be performed before sending the data over the network.

On a web and/or LAN based server associated with output and viewing system 94, the user may select the port on which the user wants to send the data. The user may be presented with the option of selecting the format of the streaming data, which may be RGB, MJPEG, MPEG4, H26, custom, or another format. MJPEG may be suggested to the user and/or presented as a default choice, because sending MJPEG is faster than sending RGB raw data. The operating system's sockets may be used to send and/or receive data over the internet. The transmission protocol used by the web and/or LAN based server may be TCP. In an embodiment, system 10 may support around 10 simultaneous clients. In another embodiment, system 10 may support an unlimited number of clients. In an embodiment, only JPEG compression is used for sending MJPEG data. In another embodiment, MPEG4 compression may be used for MJPEG data with either TCP and/or Real time Streaming Protocol (RTSP) protocols for a better performance and an improved rate of sending frames when compared with MJPEG. In an embodiment, ActiveX based clients are used for both TCP and web servers. The clients that can process ActiveX instructions (or another programming standard that allows instructions to be downloaded for use by a client) can be embedded in webpages, dialog boxes, or any user required interface. The web based client is generic to many different types of protocols. The web based client can capture standard MJPEG data not only from the VP web server, but also from other Internet Protocol (IP) cameras, such as Axis, Panasonic, etc. The resulting panorama video can be viewed over network 26 by any a client application on client system 28 using various methods. In one method, the panorama video may be viewed using any standard network video parser application. Video parsing applications may be used for viewing the panorama, because video panorama supports most of the standard video formats used for video data transfer over the network. Panorama videos may be viewed with an active X viewer or another viewer enabled to accept and process code (an active X viewer is available from IntelliVision). The viewer may be a client side viewer (e.g., an active X client-side viewer), which may be embedded into any HyperText Markup Language (HTML) page or another type of webpage (e.g., a page created using another mark up language). The viewer may be created with language, such as any application written in C++ windows application (or another programming language and/or an application written for another operating system). The panorama video may be viewed using a new application written from scratch—in an embodiment, the viewer may include standard formats for data transfer and also may provide a C++ based Application Programming Interface (API). The panorama video may be viewed using DirectShow filter provided by IntelliVision. The DirectShow filter is part of Microsoft DirectX and DirectDraw family of interfaces. DirectShow is applied to video, and helps the hardware and the Operating System perform an extra fast optimization to display and pass video data efficiently and quickly. If a system outputs DirectShow interfaces, other systems that recognize DirectShow, can automatically understand, receive, display, and receive the images and videos.

The panorama may be resizable, and may be stretched for better display. Alternatively, if the size is too big, then the scene can be reduced and focus can be shifted to a particular area of interest. It is also possible to zoom in and out on the panorama. In an embodiment, the resulting panorama that is output may be panned and/or tilted may also be supported by the system.

A result panorama video may be so large that it is difficult to show a complete panorama on a single monitor unless a scaling operation is performed to reduce the size of the image. However, scaling down may result in a loss of detail and/or may not always be desirable for other reasons. Hence, the user may want to focus on a specific region. The user may also want to tilt and/or rotate the area being viewed.

The video panorama may support a variety of operations. For example, focus may be directed to only a smaller part of the result panorama (viewing only a small part of the panorama is often referred to as zooming). The system may also provide a high quality digital zoom that shows output that is bigger than the actual capture resolution, which may be referred to as super resolution. The super resolution algorithm may use a variety of interpolations and/or other algorithms to compute the extra pixels that are not part of the original image. The system may be capable of changing the area under focus (which is referred to as panning). The user can move the focus window to any suitable position in the resultant panorama. Output and viewing system 90 may allow the user to rotate the area under focus (which is referred to as Tilt). In an embodiment, output and viewing system 94 of system 90 may support a 360 degree rotations for the area under focus.

In many video streams captured from live cameras, the elements of the image change infrequently. (e.g., the camera is mounted towards a secure area in which very few people are permitted to enter). So most of the times, frames in video captured from camera will be almost the same, which may be true for some parts of the video. That is some parts may have frequent changes but some parts will change less frequently.

System 90 may be capable of understanding and distinguishing that there are no changes in certain part of the video and therefore the video panorama system does not render that that part of that frame in the panorama result video. Also only the updated data is sent over the network. Not rendering the parts of the image that do not change and only transmitting the changes reduces the processing and results in less Central Processor Unit (CPU) usages than if the entire image is rendered and transmitted. Only sending the changes also reduces data sent on network and assists in sending video at a rate of at least 30 Frames Per Second (FPS) over the network.

The video panorama system also understands and identifies the changes in each of the video frames, and the video panorama system renders the changing parts accurately in the resulting panorama view (and in that way can be called intelligent). The changing part may also be sent over network 26 after being rendered. Sending just the changes facilitates sending high quality high resolution panorama video over network 26.

An option may be provided for saving the panorama as a still image on a hard disk or other storage medium, which may be associated with memory system 36. The user may be given the option to save the panorama still image in any standard image format. A few examples of standard image formats are jpeg, bit maps, gif, etc. Another option may be offered to the user for saving panorama videos. Using the option to save panorama videos, the user may be able to save the stitched panorama videos on a hard disk or other storage medium. The user may be able to save the panorama in any standard video format. Few examples of standard video formats are—avi, mpeg2, mpeg4 etc

Once the user determines some settings for making a final panorama from a group of source images, the user may be offered the option of saving those settings to a file, which may contain some or all of the information for the panorama stitching, rendering, and joining. Using the panorama data file, the next time the same set of cameras are located at the same positions, the settings can be loaded automatically. The details derived from which images and/or videos were used to create the panorama and the actual stitched output image may be stored in this data file.

System 90 may include other features. For example, system 90 may self-adjust and/or self-correct stitching over time. System 90 may adjust the images and/or videos to compensate for camera shakes and vibrations. In an embodiment, the positions and/or angles of the images or videos may be adjusted to keep the titles and imprinted letters or text in fixed positions. If two points or nodes from different images that are the same can be automatically found, then the system will automatically snap the two images together and align them with each other, which is referred to as self adjusting. The self adjusting may be performed by performing an automatic recognition and point correlation, which may use template matching and/or other point or feature matching techniques to identify corresponding points. If points that are same are matched, then system 90 can align the images and self correct the alignment (if the images are not aligned correctly).

In an embodiment system 90 self-adjusts and self-corrects stitching over time. One of the features provided by the system 90 is to self-adjust and correct itself over time. System 90 can review the motions of objects and the existence of objects to determine whether an object has been doubled and whether an object has disappeared. Both of object doubling and object disappearance may be the results of errors in the panorama stitching. By using object motions, object doubling and object disappearance can be automatically determined. Then an offset and/or adjustment may be required to reduce or eliminate the double appearance or the missing object. Other errors may also be detectable. Hence the panorama stitching mapping can be adjusted and corrected over time, by observing and finding errors.

In an embodiment, system 90 may adjust for camera shakes and vibrations. The cameras can be in different locations and can move independently. Consequently, some cameras may shake while others do not. Video stabilization of the image (even though the camera may still be shaking) can be enabled and the appearance of shakes in the image can be reduced and/or stopped in the camera. Stabilization of the image uses feature points and edges, optical flow points and templates to find the mapping of the features or areas to see if the areas have moved. Consequently, individual movements in the image that result from camera movements or shakes can be arrested to get a better visual effect. Templates are small images, matrixes, or windows. For example, templates may be 3×3, 4×4, 5×5, or 10×10 arrays of pixels. Each array of pixels that makes up a template is matched from one image to another image. Matching templates may be used to find corresponding points in two different images or of correlating a point, feature, or node in one image to another corresponding point, feature, or node in the other image. For the window formed around a point, the characteristics of the window are determined. For example, the pixel values, a signature, or image values for the pixels are extracted. Then characteristics of the template are determined for a similar template on another image (which may be referred to as a target image) and a comparison is made to determine whether there is a match between the templates. A match between templates may be determined based on a match of the colors, gradients, edges, textures, and/or other characteristics.

In an embodiment, system 90 may be capable of keeping the titles and imprinted letters or text in fixed position or removing them. Sometimes text, closed captions, or titles may be placed in the individual images. These text or titles may be removed, repositioned, or aligned in a particular place. The text location, size, and color may be used to determine the text. Then the text may be removed or replaced. The text can be removed by obtaining the information hidden by the text and negating the effect of the inserted image, in order to make the text disappear. Additionally a new text can be created or a new title or closed caption can be created in the final panorama in addition to, or that replaces text in the original image.

### Automatic Stitching

FIG. 2A is flowchart of an example of automatically stitching a scene together. Method 200 may be implemented by automatic stitcher system 100. In an embodiment, an arbitrary number of images or video streams may be stitched together via method 200. The stitching may include at least of two stages, which are configuration, step 201, and rendering, step 202. During the configuration step (or phase) mappings are determined that map input still images or videos to a desired output scene. The determination of the mappings may involve determining a mapping from one input mage to other input images and/or may involve building a model (e.g., a model of the three dimensional layout) of the scene being photographed or filmed. During the rendering step (or phase), the source images or videos are rendered into one panorama image. The configuration is discussed below in conjunction with FIG. 2B rendering is discussed below in conjunction with FIG. 3.

In an embodiment, each of the steps of method 200A is a distinct step. In another embodiment, although depicted as distinct steps in FIG. 2A, step 201 and 202 may not be distinct steps. In other embodiments, method 200A may not have all of the above steps and/or may have other steps in addition to or instead of those listed above. The steps of method 200A may be performed in another order. Subsets of the steps listed above as part of method 200A may be used to form their own method.

### Configuration Phase

FIG. 2B is flowchart of an example of configuring a scene together. Method 200B may be implemented by automatic stitcher system 100. In step 203, during the configuration, the mapping for each source image or video stream is estimated. In this specification the terms source image or source video are interchangeable with input image or input video. In an embodiment, the configuration stage utilizes still images. In order to handle videos, the frames of a set of frames taken at the same time or moment are stitched to one another.

Multiple images that are input from a single video may also be used. For example, a single camera may be rotated (e.g., by 180 degrees or by a different amount) one or multiple times while filming. The video camera may swipe a scene or gently pan around and capture a scene. Sequences of images in from each rotation may be combined to from one or more panorama output images. As an example, the video may be divided into multiple periods of time that are shorter than the entire pan or rotation, and one can collect multiple images, in which each image comes from a different one of the periods. For example, one frame may be taken every N frames, every 0.25 seconds, or even every frame image. Then the images may be taken as individual images and joined into a panorama image as output. In other words, a user may swipe the scene with a single video camera, which creates just one video. From this one video, system 10 may automatically extract various sequential frames and take multiple images from the video. In an embodiment not every frame from the video is used. In another embodiment every frame from the video is used.

In step 203, mappings are estimated as part of the configuration stage. The mappings may unambiguously specify the position of each source image point or video image point in the final panorama. There are at least three types of mappings that may be used, which are (1) affine mappings (which are linear) in which a linear transformation is applied uniformly to each point of the image, (2) perspective mappings (which are non-linear) in which the transformation applied foreshortens the image according to the way the image would appear from a different perspective, and (3) graph and mesh-based mappings (which are non-linear) are used in which a mesh is superimposed over an image and then nodes of the mesh are moved, thereby distorting the mesh and causing a corresponding distortion in the image. To estimate the final mapping for each source, it is sufficiently to estimate the mapping between the pairs of overlapping source images or videos.

The problem of mapping estimation between a pair of overlapped source images can be formulated as follows. Mapping estimation requires finding the mapping from one image to the other image, such that the objects visible on the images are superposed in a manner that appears realistic and/or as though the image came from just a single frame of just one camera. At least three ways of initially estimating the mapping may be used, which may include manual alignment, a combination of manual alignment and auto refinement, and fully automatic alignment. In the case of a manual mapping estimation, the mapping between the pair of images is specified by the user. At least two options are possible: manually selecting corresponding feature points, or manually aligning each of the images as a whole.

In the case of estimating a mapping for manual alignment plus auto refinement the initial mapping is specified by the user as is described above (regarding manual mapping). To reduce the user interaction and increase the accuracy of the estimation, the manual stage is followed by a auto refinement procedure for refining the initial manual mapping.

A fully automatic mapping estimation may also be implemented. Unique features are extracted from each source image. For example, edges, individual feature points, or feature areas may be identified as unique features. The edges in a scene that may be used as unique features are those that are easily recognizable or easily identifiable, such edges that are associated with a high contrast between two regions—each region being on a different side of the edge. Feature points or feature areas, may be represented by one of several different methods. In one method, a small template window having an M×N matrix of pixels (with color values RGB, YUV, HSL, or another color space) within which the feature is located may be established to identify a feature. In another method, a unique edge map may be associated with a particular feature and that is located in the M×N matrix, which may be used to locate certain features. Scale-invariant feature-transforms or high curvature points may be used to identify certain features. In other words, features are identified that are expected not to change as the size of the image changes. For example, the ratio of sizes of features may be identified. Special corners or intersection points of one or more lines or curves may identify certain features. The boundary of a region may be used to identify a region, which may be used as one of the unique features.

In step 204, after extracting points or small features using all the feature pairs (each image has one of the members of the pair) that represent exactly the same object are identified. After identifying the pairs, the mapping is estimated. Optionally, the estimated mapping may be refined by applying the mapping refinement procedure. The mapping refinement procedure estimates a more accurate mapping (than the initial mapping) given a rough initial mapping on input. The more accurate mapping may be determined via the following steps.

In step 206, easily identifiable features (such as the unique features discussed above) are identified on one of the images (if features are identified manually, the system will refine the mapping automatically).

In step 208, a feature correlation and matching method is applied, such as template matching, edge matching, optical flow, mean shift, or histogram matching, etc. In step 210, once more accurate feature points on one image and the corresponding features on the other image have been identified, an estimate of a more accurate mapping may be determined. After step 210, the method continues with method 300 of FIG. 3 for performing the rendering.

In an embodiment, each of the steps of method 200B is a distinct step. In another embodiment, although depicted as distinct steps in FIG. 2B, step 203-210 may not be distinct steps. In other embodiments, method 200B may not have all of the above steps and/or may have other steps in addition to or instead of those listed above. The steps of method 200B may be performed in another order. Subsets of the steps listed above as part of method 200B may be used to form their own method.

### Rendering Phase

FIG. 3 shows a flow chart an example of a method 300 of rendering the images produced by stitching and viewing system 100. Method 300 is an example of method which rendering system 92 may implement. In step 302, a choice is made as to how to create the joined image and/or video scene. The user may choose to create a joined image/video scene created using software maps. The user may choose to create the joined image using hardware texture mapping and 3D acceleration (or other hardware or software for setting aside resources for rendering 3D images and/or software for representing 3D images). In step 304, the image is rendered. In an embodiment, the image is rendered only in portions of the image or video that have changed. In step 306, blending and smoothening is performed at the seams and interior for better realism. In step 308, the brightness and/or contrast are adjusted to compensate for differences in brightness and/or contrast that result from joining images and/or video into a scene.

In an embodiment, each of the steps of method 300 is a distinct step. In another embodiment, although depicted as distinct steps in FIG. 3, step 302-308 may not be distinct steps. In other embodiments, method 300 may not have all of the above steps and/or may have other steps in addition to or instead of those listed above. The steps of method 300 may be performed in another order. Subsets of the steps listed above as part of method 300 may be used to form their own method.

### Output and View

FIG. 4 is a flowchart of an example of a method 400 of outputting and viewing scenes. During the output process the viewer may be given an opportunity to change the stitching (e.g., the configuration and/or rendering) or how the stitching is performed. Method 400 is an example of a method that may be implemented by output and viewing system 94. In step 402 the file is output. Outputting the file may include choosing whether to output the file to a hard disk, to a display screen, for remote viewing, or over network. In step 404, a choice is made as to which portion of the scene to view, if it is desired to only view a portion of the scene. In step 406, the scene is panned, tilted, and/or zoomed, if desired by the user. In step 408, the changes in the scene are sent for viewing. Step 408 is optional. In step 410, the scene that is output is sent and viewed.

In an embodiment, each of the steps of method 400 is a distinct step. In another embodiment, although depicted as distinct steps in FIG. 4, step 408-410 may not be distinct steps. In other embodiments, method 400 may not have all of the above steps and/or may have other steps in addition to or instead of those listed above. The steps of method 400 may be performed in another order. Subsets of the steps listed above as part of method 400 may be used to form their own method.

### Points-Based Alignment

FIG. 5 is a flowchart for an example of a method 500 of joining images or videos into a scene based on point. Method 500 may be implemented by points based module. Method 500 may be incorporated within an embodiment of step 201 of FIG. 2A or 203 of FIG. 2B. In step 502, the mapping between two images can be estimated given a set of corresponding points or feature pairs. In order to stitch two images using an affine mapping, at least three non-collinear point pairs are desirable. For performing a perspective mapping estimation four point pairs are desirable.

In step 504, the mapping may be estimated by solving a linear system of equations. A standard linear set of equations will solve for the position matrix to transform the second image to exactly match and align with the first image.

The features or points may have been computed automatically or may have been manually suggested by the user (mentioned above). In both cases the feature points can be imprecise, which leads to imprecise mapping. For an accurate mapping, it is possible to use more than three (four) point pairs. In this case the mapping which minimizes the sum of squares of distances (or a similar error minimizing method) between the actual points on the second image and the point from the first image mapped to the second one is estimated. The mapping may be estimated in a way that is more precise and robust for inaccurate point coordinates. If more than three points are available for the affine mapping, a least square fit may be used. Similarly, if more than four points are available for the perspective mapping, a least square fit or similar error minimization method may be used.

In an embodiment, each of the steps of method 500 is a distinct step. In another embodiment, although depicted as distinct steps in FIG. 5, step 502-504 may not be distinct steps. In other embodiments, method 500 may not have all of the above steps and/or may have other steps in addition to or instead of those listed above. The steps of method 500 may be performed in another order. Subsets of the steps listed above as part of method 500 may be used to form their own method.

### Outer Boundary-Based Alignment

FIG. 6 is a flowchart of and example of a method 600 of manually aligning images or videos based on the outer boundary. Method 600 may be incorporated within an embodiment of step 201 of FIG. 2A or 203 of FIG. 2B. Method 600 may be implemented by boundary based-alignment. To perform a unique manual alignment, users can manually provide the initial approximate alignment in step 601. In an embodiment, manual arrangement (e.g., via method 500) is provided in the system as a backup method. In step 602, the user can select any number of images and the user's selection is received by system 90. As part of step 604, when the user selects the required image, some visual markers (such as anchor points) are automatically drawn on the image. In an embodiment, in step 606, the selected image is drawn on the stitching canvas. In step 608, using the visual markers (e.g., the anchor points), the user may manipulate the image. For example, as part of step 608, the user may rotate, translate, stretch, skew, and/or manipulate the image in other ways. As part of step 608, the user may pan and/or tilt the stitching canvas based on the region of interest. The system can then refine the alignment automatically in step 610.

In an embodiment, each of the steps of method 600 is a distinct step. In another embodiment, although depicted as distinct steps in FIG. 6, step 602-610 may not be distinct steps. In other embodiments, method 600 may not have all of the above steps and/or may have other steps in addition to or instead of those listed above. The steps of method 600 may be performed in another order. Subsets of the steps listed above as part of method 600 may be used to form their own method.

FIG. 7 shows an example of several images 700a-d being aligned at different perspectives. Images 700a-d include objects 702a-d and anchor points 704a-d, respectively. In other embodiments, images 700a-d may not have all of the elements listed and/or may have other elements instead of or in addition to those listed. Objects 702a-d are the objects selected by the user, which may be manipulated by method 600 of FIG. 6, for example. Anchor points 704a-d may be used by the user for moving, rotating user, and/or stretching the image. Images 700a-d show some examples of the different types of panning and tilting of the image that the user can perform using the system.

### Mesh Based or Graph Based Alignment

FIG. 8 shows a flowchart of an embodiment of a method 800 for a graph based alignment. In step 802, a mesh or graph is determined, and the image is broken into the mesh or graph. In step 804, nodes of the mesh or graph are placed at edges of objects and/or strategic locations within objects.

Step 804 may be a sub-step of step 802. In step 806, the graph or mesh is stretched individually by moving the nodes. One difference between method 600 and method 800, is that method 600 references the outer boundary based stretching and aligning. Method 800 shows how to move the images in a non-linear way and align the individual graph node or mesh. Most (possibly all) of the mesh may be made from triangles, quads, and/or other polygons. Each of the nodes or points of the graph or mesh, can be moved and/or adjusted. Each of the triangles, quads, and/or other polygons can be moved, stretched, and/or adjusted. These adjustments occur inside the image and may not affect the boundary. The adjustments may be restricted by one or more constraints. Some examples of constraints are one or more points may be locked and prohibited from to being moved. Some examples of constraints are some points may be allowed to move, but only within a certain limited region and some points may be confined to being located along a particular trajectory. Some points may be considered floating in that these points are allowed to be moved. If each point is a node in a mesh, moving just one point without moving the other points distorts the mesh or graph. Some points may be allowed to move relative to the canvas or relative to background regions of the picture, but are constrained to maintain a fixed location relative to a particular set of one or more other points. By constraining the image (e.g., by locking or restricting the movement of some points with respect to one another and/or with respect to the canvas) while allowing other points to move, the user may sometimes create a very powerful and highly complex non-linear mapping that is not possible to perform automatically.

In an embodiment, each of the steps of method 800 is a distinct step. In another embodiment, although depicted as distinct steps in FIG. 8, step 802-806 may not be distinct steps. In other embodiments, method 800 may not have all of the above steps and/or may have other steps in addition to or instead of those listed above. The steps of method 800 may be performed in another order. Subsets of the steps listed above as part of method 800 may be used to form their own method.

FIG. 9A shows an example of an unaltered image 900A created with constrained points having floating points 902a-c and anchored points 904a-g. In other embodiments, unaltered image 900A may not have all of the elements listed and/or may have other elements instead of or in addition to those listed. Floating points 902a-c are allowed to float, and fixed points 904a-g are constrained to fixed locations.

FIG. 9B shows an example of an altered image 900B created with constrained points having floating points 902a-c and anchored points 904a-g. In other embodiments, altered image 900B may not have all of the elements listed and/or may have other elements instead of or in addition to those listed. Floating points 902a-c and fixed points 904a-g were discussed above. In altered image 900B, floating points 902a-c have been moved. Thus, FIG. 9A is an example of an image prior to performing any transformation, and FIG. 9B shows the image after being transformed while allowing some points to float and constraining other points to have a fixed relationship to one another.

FIG. 9C shows an example of an image prior to adding a mesh. FIG. 9D shows the image of FIG. 9C after a triangular mesh was added.

### Stitching Based on Common Moving Object

FIG. 10 shows a flowchart of an example a method 1000 of joining images based on a common moving object. Method 1000 may be incorporated within an embodiment of step 201 of FIG. 2A or 203 of FIG. 2B. A mapping from one perspective to another perspective is automatically calculated based on the common moving object. In step 1002, a scene is photographed by multiple cameras and/or from multiple perspectives having one or more objects present. In steps 1004, an algorithm is applied to determine the position of the same object in each of the multiple scenes, that represent the same time or in which the scene is expected to have not changed. In step 1006, the location of the object in each scene is marked as the same location no matter which image the object appears in or which camera took the picture. Hence, in a way, a common moving object may act as an automatic calibration method. The complete track and position of the moving object is correlated to determine the alignment of the images with respect to one another.

In contrast, graph or mesh based stitching is based on fixed and non-moving part of the image. For example mesh/graph based stitching will use the door corner, edges on the floor, trees, parked cars, as nodes. The points that mesh based stitching uses to align the images are fixed features. In contrast to the graph or mesh based stitching, in the moving features based stitching, other clues on how to stitch and align images are used, which are moving objects or moving features, such as a person walking or a car moving. Points on the moving object can also be used to align two images.

Motion may be detected in each video, and corresponding matching motions and features may be aligned. The moving features that may be used for matching moving objects may include corners, edges, and/or other features on the moving objects. By matching corresponding moving features, a determination may be made whether two moving objects are the same, even if the two videos show different angles, distance, and/or views. Thus, two images may be aligned based on corresponding moving objects, and corresponding moving objects may be determined based on corresponding moving features.

In an embodiment, each of the steps of method 1000 is a distinct step. In another embodiment, although depicted as distinct steps in FIG. 10, step 1002-1006 may not be distinct steps. In other embodiments, method 1000 may not have all of the above steps and/or may have other steps in addition to or instead of those listed above. The steps of method 1000 may be performed in another order. Subsets of the steps listed above as part of method 1000 may be used to form their own method.

### Depth Adjustment

FIG. 11 is a flowchart of an embodiment of a method 1100 of adjusting the scene by adjusting the depth of different objects. After aligning multiple images, each image position or depth can be adjusted. In step 1102, the user may select one or more objects and/or images with the intent of pushing back and or pulling forwards the object and/or image. In step 1104, the depth of the selected image is adjusted. Adjusting the depth is desirable primarily in the overlapping areas, assuming there are one or more common overlapping areas. It may be useful to determine which image better represents an overlapping area. By adjusting the depth associated with one or more images and/or order in which images are stitched together, some overlapping images can be pushed forward (so that the images of the edges of the images are no longer obscured from view) to be seen. Other images may be pushed back (and obscured from view). Changing the depth of the images and/or changing which images are obscured from view (by other images) and which images are not obscured from view can be powerful method to select the preferred order of viewing and obtaining the stitched image that the user likes the best. Some images may be moved forwards or backwards to compensate for the differences among the cameras in distances from the cameras to the objects of interest. The compensation may be performed by scaling one or more of the input images so that the size of the object is the same no matter which scaled input image is being viewed. Depth information can be gathered or extracted from multiple images, from the position of the pixels at a top or bottom of the edge, and from the special relationship with other points, and/or from the depth of neighboring points.

In an embodiment, each of the steps of method 1100 is a distinct step. In another embodiment, although depicted as distinct steps in FIG. 11, step 1102-1104 may not be distinct steps. In other embodiments, method 1100 may not have all of the above steps and/or may have other steps in addition to or instead of those listed above. The steps of method 1100 may be performed in another order. Subsets of the steps listed above as part of method 1100 may be used to form their own method.

### Rendering System

FIG. 12 is a flowchart of an embodiment of a method 1200 of rending an image, which may be implemented by rendering system 92. In step 1202, an image and/or video scene is joined. The joining may employ software and maps indicating how to stitch the images together. To render the resultant joined panorama image each of the initial individual images should be appropriately transformed and placed into the final image. For fast rendering of a panorama the map may be used. The map may be a grid that is the same size as the final image size of panorama created from the individual images. Each map element may correspond to a pixel in the panorama image. Each map element (e.g., each pixel in the panorama) may contain (or be labeled or otherwise associated with) a source image ID and an offset value (which may be in an integer format). For example, a panorama map may contain the individual pixel's image of origination and more information, such as offsets and an x,y coordinate location. Below is an example of a table of integer offsets. Each location in the table corresponds to a different x,y coordinate set. The values in the table are the offsets in the pixel values that need to be added to the pixel values of the input images.

| | | | | |
|---|---|---|---|---|
| 1 | 1 | 2 | 2 | 3 |
| 1 | 2 | 2 | 3 | 3 |
| 1 | 2 | 2 | 2 | 3 |
| 2 | 2 | 3 | 3 | 4 |

The initial pixels or two dimensional array of points are fixed X and Y coordinates that have integer values. Optionally, each X and Y location may be associated with a depth or Z value. A transformation may be applied that represents a change in perspective, depth, and/or view. During the transformation each of the integer X and Y values may be mapped to a new X and Y value, which may not have an integer value. The new X and Y values may be based on the Z value of the original X and Y location. Then the pixel values at the integer locations are determined based on the pixel values at the non-integer locations. Since final result is also a two dimensional array in which all pixels are in integer valued X and Y locations only. The floating point and Z values of points are only for intermediate calculations for mathematics. The final results are only a two dimensional image.

During the setup stage the map may be filled with the actual values in the following way. Each pixel of the panorama may be back-projected into each source image coordinate frame. If the projected pixel lies outside all of the source images, then the corresponding map element ID may be set to 0. During the rendering such pixels may be filled with a default background color. Otherwise, for those pixels that have corresponding pixels in other source images, there will be one or more source images that overlap with the pixel on the panorama that is being considered. Among all of the source images having the points that overlap with the pixel, the topmost source image is selected and the corresponding map element ID is set to the ID determined by the selected image. The map element offset value is a difference between two pixel values that are located at the same location. The offset is the amount by which the pixel value must be increased or decreased from its current value. The offset may be the difference in value between a pixel of the topmost image and a pixel of the current source image, which must be added to the topmost pixel so that the image has a uniform appearance. For example, the topmost image may be too bright, and consequently the topmost pixel may need to be dimmed.

The setup only needs to be performed once for each configuration. After the setup, the fast rendering can be performed an arbitrary number of times. After the setup, the rendering is performed as follows. For each panorama pixel the source image ID and source image pixel offset are stored in the map. Each final panorama pixel is filled with the color value from the given source image taken at a given offset. The color value is pre-computed to avoid performing a run-time computation. If the source image ID is 0, then such pixel is filled with the background color.

In other words, for one frame (e.g., the first frame), a transformation for each pixel of each image is obtained from each source image to the topmost source image, for example. The transformation is used to determine transformations for each pixel in each source image for a desired view, which may not correspond to any source image, and then the same transformation is applied to all subsequent frames.

Computing the pixel values based on the offset is fast, but the interpolation between pixels may result in an image that has some seams or somewhat noticeably unnatural transitions. To render the smoother image instead of using the same offset value of each pixel element, may contains a floating point value for the X and Y coordinates of each source image pixel (instead of an integer value. During the rendering, the source image pixel neighborhood is used as a basis for interpolation in order to obtain the panorama pixel color value. Further, an interpolation may be performed by providing and/or storing additional information and/or by performing additional computations. The extra information may be included within the panorama map).

In step 1204, a joined image is created with a hardware texture mapping and a 3D acceleration. Hardware based rendering of a panorama may use texture mapping and 3D acceleration, DirectX, OpenGL (other graphics standard) rendering available in many video cards. The panorama may be divided into triangles, quadrilaterals and/or other polygons. The texture of each of the areas (the triangles or other polygons) is initially computed from the original image. The image area texture is passed to the 3D rendering as a polygon of pixel locations. Hardware rendering may render each of the polygons faster than software methods, but in an embodiment may only perform a linear interpolation. The image should be divided into triangles and/or other polygons that are small enough, such that linear interpolation is sufficient to determine the texture of a particular area in the final panorama.

In step 1206, the portion that changes is rendered. In an embodiment, only the portion that changed is rendered. In many video streams captured from live cameras, many of the objects (sometimes all of the objects) change very infrequently. For example, the camera may be mounted to face towards a secure area into which very few people tend to enter. Consequently, most of the time, frames in the video captured from the camera will be almost the same. For example, in a video of a conversation between two people that are sitting down while talking, there may be very little that changes from frame to frame. Even in videos that have a significant amount of action, there may still some parts of the video that change very little. That is some parts of the image may tend to have frequent changes but some parts may tend to change less frequently.

In a video panorama, understanding (e.g., identifying) that there are no changes in certain part of the video allows the user or the system to not render that part of that frame in the resulting panorama result video. The rendered part of the frame may be added to the non-changing part of the frame after rendering. This reduces the processing and results in less CPU usage than were the entire frame rendered. Having the system understand (e.g., identify) the portions of the frames that contain changes allows the system to always render these parts of the image accurately in the resulting panorama view.

The portions that change may be identified by computing the changes in the scene first. Pixel differencing methods may be used to identify motion. If there is no motion in a particular area, then that area, region, or grid does not need to be rendered or sent for display. Instead, the previous image, grid, or region may be used in the final image, as is.

In step 1208, the seams are blended and smoothened at the seams and interior for better realism. The images from different cameras when joined, may look a bit different or un-natural at the joining seams. Specifically, the seams where the images were joined may be visible and may have discontinuities that would not appear in an image from a single source. Blending and smoothening at the seam of stitching improves realism and makes the image appear more natural. To smooth the seam, the values for the pixels at the seam are first calculated, and then at and around the seams, the brightness, contrast, and colors are adjusted or averaged to make the transition from one source image to another source image of the same panorama smoother. The transition distance (the distance from the seam over which the smoothening and blending are applied) can be defined as a parameter in terms of the percentage of pixels in the image or total number of pixels.

In step 1210, the brightness and contrast are adjusted. Adjusting the brightness and contrast may facilitate creating a continuous and smooth panorama effect. When a user plays the stitched panorama, it is possible to adjust the brightness of adjacent frames fed by different cameras and/or videos so that which regions of the image are taken from different source cameras is not as apparent (or not noticeable at all). It is possible that due to different camera angles, the brightness of the frames may not be the same. So to create a continuous panorama effect, the brightness and/or contrast are adjusted. Also the adjacent frames that may overlap each other during stitching can be merged at the boundaries. Adjusting the brightness and/or contrast may remove the jagged edge effect and may provide a smooth transition from one frame to another.

In an embodiment, each of the steps of method 1200 is a distinct step. In another embodiment, although depicted as distinct steps in FIG. 12, step 1202-1210 may not be distinct steps. In other embodiments, method 1200 may not have all of the above steps and/or may have other steps in addition to or instead of those listed above. The steps of method 1200 may be performed in another order. Subsets of the steps listed above as part of method 1200 may be used to form their own method.

FIG. 13A shows an example of an image 1300a that has not been smoothed. Image 1300a has bright portion 1302a and dim portion 1304a. In other embodiments, image 1300A may not have all of the elements listed and/or may have other elements instead of or in addition to those listed.

Image 1300A is an image that is formed by joining together multiple images. Bright portion 1302a is a portion of image 1300a that is brighter than the rest of image 1300A. Dim portion 1304a is portion of image 1300A that is dimmer than the rest of the image 1300A. The transition between bright portion 1302a and dim portion 1304a is sharp and unnatural.

FIG. 13B shows an example of an image 1300B that has been smoothed. Image 1300b has bright portion 1302b and dim portion 1304b. In other embodiments, image 1300B may not have all of the elements listed and/or may have other elements instead of or in addition to those listed.

Image 1300B is image 1300A after being smoothed. Bright portion 1302b is a portion of image 1300B that was initially brighter than the rest of image 1300B. Dim portion 1304b is portion of image 1300B was initially dimmer than the rest of the image 1300B. FIG. 13B, the transition between bright portion 1302b and dim portion 1304b is smooth as a result of averaging. The brightness is not distinguishable between bright portion 1302b and dim portion 1304b.

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A method comprising:
determining at least at least one unique aspect that is found in at least two images or videos, each image or video representing a different perspective;
determining a transformation that maps the at least two images or videos into a single image or video; and
forming a single image or video from the at least one image or video by at least applying the transformation determined.

2. The method of claim 1, the single image or video formed is a panorama that includes at least a first portion that is shown in multiple images or videos of the at least two images or videos, a second portion that is not shown in at least a first of the at least two images, and a third portion that is not shown in at least a second of the at least two images.

3. The method of claim 2, further comprising within the first portion offering a user a choice of displaying image information taken from a first of the at least two images or videos or displaying image information from taken from a second of the at least two images or videos.

4. The method of claim 1, the single image or video formed has a perspective that is not shown in any of the at least two images or videos.

5. The method of claim 4, the determining of the transformation including at least computing a three dimensional model of objects in the at least two images, and the single image formed having the perspective is based on the transformation.

6. The method of claim 1, further comprising
capturing a first image or video from a first input image or video
capturing a second image or video from a second input image or video,
information for a first portion of the single image formed being taken from the first image
information for a second portion of the single image formed being taken from the second image
adjusting a brightness of a first portion of the single image or video formed to match a brightness of the second portion of the single image or video formed.

7. The method of claim 1, further comprising
capturing a first image or video from a first input image or video
capturing a second image or video from a second input image or video,
information for a first portion of the single image formed being taken from the first image
information for a second portion of the single image formed being taken from the second image
adjusting a contrast of a first portion of the single image or video formed to match a contrast of the second portion of the single image or video formed.

8. The method of claim 1, the at least one unique aspect including a moving object that is found in each of the at least two images or videos.

9. The method of claim 1, the at least one unique aspect including an edge feature of an object that is found in each of the at least two images or videos.

10. The method of claim 1, the determining of the transformation including at least
determining a first mesh of points on at least a first of the at least two images or videos; and
determining a second mesh of points on at least a second of the at least two images or videos; and
determining a transformation includes at least determining a transformation between at least one of the points of the first mesh and at least one of the points of the second mesh.

11. The method of claim 1, the determining of the transformation including at least
determining a mesh of points on at least one of the images or videos;
constraining movement of at least one of the points of the mesh; and
moving at least one unconstrained point, which is a point that does not have a constrained movement.

12. The method of claim 1, further comprising prior to the forming of the single image,
identifying an object that is being videoed;
determining that the object moves within a video segment from a camera in a manner that is expected to be a result of the camera shaking, the video segment including a set of frames from the camera;
adjusting positions at least portions of the video to remove motion of the object that is expected to be a result of the camera shaking.

13. The method of claim 1, the determining of the transformation including at least
determining a first texture of map of a first of the at least two images;
determining a second texture of map of a second of the at least two images;
determining a transformation from the first texture map to the second texture map; and
determining a transformation that maps the at least two texture maps into an image based on the transformation of the first texture map to the second texture map.

14. The method of claim 1, further comprising:
determining a portion of the image or video formed that changed;
rendering an update of only the portion of the image or video formed that changed;
combining the update with a portion of the image or video formed that did not change; and
sending for display a resulting image or video of the combining.

15. The method of claim 1, the method further comprising
capturing a first image or video from a first input image or video
capturing a second image or video from a second input image or video,
information for a first portion of the single image formed being taken from the first image;
information for a second portion of the single image formed being taken from the second image;
adjusting a brightness and a contrast of a first portion of the single image or video formed to match a brightness and a contrast of the second portion of the single image or video formed;
the single image or video formed is a panorama that includes at least
a first portion that is shown in multiple images or videos of the at least two images or videos,
a second portion captured by the first camera that is not shown in at least a first of the at least two images, and
a third portion captured by the second camera that is not shown in at least a second of the at least two images;
the determining of the transformation including at least computing a three dimensional model of objects in the at least two images, and the single image formed being based on the transformation;
within the first portion offering a user a choice of displaying image information taken from a first of the at least two images or videos or displaying image information from taken from a second of the at least two images or videos;
determining a first texture of map of a first of the at least two images;
determining a second texture of map of a second of the at least two images;
determining a transformation from the first texture map to the second texture map; and
determining a transformation that maps the at least two texture maps into an image based on the transformation of the first texture map to the second texture map;
prior to the forming of the single image,
identifying an object that is being videoed;
determining that the object moves within a video segment from a camera in a manner that is expected to be a result of the camera shaking, the video segment including a set of frames from the camera;
adjusting positions at least portions of the video to remove motion of the object that is expected to be a result of the camera shaking.

16. A system comprising a machine-readable medium that stores instructions that cause a processor to implement the method of claim 1.

17. A system comprising:
one or more machines configured for
merging or joining two videos, two frames of one video, or two images into one video or still image, and
efficiently storing, displaying, and transmitting to the one video or still image, results from the merging or joining, to the one or more machines or to another external device.

18. The system of claim 17, the two videos or images being a multiplicity of videos or images, the method further comprising:
a multiplicity of cameras, each camera photographing a different portion of a scene, and the merging or joining of the two videos or images being a merging or joining of the multiplicity of videos or images that forms a panorama of the scene.

19. A system comprising
only one video input;
a processor configured for
extracting from only the one video or set of still images a sequence of images including different viewing angles,
inputting the sequence of images to a panorama creation portion of the system and
creating a panorama from the sequence of images; and
an output for displaying, storing, or sending the result wirelessly or over a network for display;

20. The system of claim 19, the processor being configured such that the sequence of images does not include all images of the one video or set of still images.
